(19) United States
(12) Patent Application Publication
(10) Pub. No.: US 2017/0200020 A1
(43) Pub. Date: Jul. 13, 2017

(54) DATA MANAGEMENT SYSTEM, PROGRAM RECORDING MEDIUM, COMMUNICATION TERMINAL, AND DATA MANAGEMENT SERVER

(71) Applicant: Showcase-TV Inc., Tokyo (JP)

(72) Inventors: Toyoshi NAGATA, Tokyo (JP); Koji YUGETA, Tokyo (JP)

(73) Assignee: Showcase-TV Inc., Tokyo (JP)

(21) Appl. No.: 15/295,067

(22) Filed: Oct. 17, 2016

(30) Foreign Application Priority Data
Jan. 13, 2016 (JP) 2016-004 720

(51) Int. Cl. G06F 21/62; H04L 9/08; H04L 29/06

(52) U.S. Cl. CPC G06F 21/6227; H04L 63/0428; H04L 9/0894; H04L 2209/24

(57) ABSTRACT

A data management system with which secret data is hardly leaked to a third party. A communication terminal of the present invention generates an encryption key and a data ID using a terminal identification ID of the communication terminal, encrypts the secret data using the encryption key, and causes a data management server to associate the secret data encrypted through this encryption with the data ID and to store the associated data and ID. In addition, the communication terminal of the present invention generates again the encryption key and the data ID using the terminal identification ID internally stored in the communication terminal, requests the secret data corresponding to the data ID from the management server, and decrypts the received secret data using the encryption key.

### BACKGROUND OF THE INVENTION

Field of the Invention

The present invention relates to a technique for securely storing, in a data management server, secret data generated by a communication terminal and, specifically, to a data management system, a program recording medium, a communication terminal and a data management server that use this technique.

Description of the Prior Art

Conventionally, as a technique for storing and managing secret data in a server, for example, a technique disclosed in Japanese Patent Laid-Open No. 2015-207205 has been known.

In the technique described in Japanese Patent Laid-Open No. 2015-207205, personal information is encrypted and stored in a server (personal information database). According to the technique, a decryption key (or session information for generating the decryption key; hereinafter, simply denoted as the decryption key) used to decrypt the encrypted personal information in the server is not stored in the sever, and the key is received from a user terminal as required instead in order to prevent leakage of the personal information.

However, in the technique in Japanese Patent Laid-Open No. 2015-207205, the decryption key is transmitted from the user terminal to the server every time of encryption. Consequently, there is a risk that the decryption key may be leaked to a third party on a communication line and the secret data may thus be leaked.

In the technique of Japanese Patent Laid-Open No. 2015-207205, the correspondence relationship between the secret data and the decryption key is identified according to an authentication ID. Consequently, in case of the authentication ID being leaked on a communication line, there is a risk that the corresponding user terminal may be identified and the secret data may be leaked. Furthermore, terminal users often keep their authentication IDs in the form of a memorandum or the like. Consequently, there is also a risk that the ID may be identified at places other than the communication line and the secret data may be leaked.

### SUMMARY OF THE INVENTION

An object of the present invention is to provide a data management system, a data management program, a communication terminal and a data management server with which secret data is hardly leaked to a third party.

To achieve such an object, a data management system according to the present invention is a data management system in which secret data encrypted in a communication terminal is transmitted to and stored in a data management server, and the secret data stored in the data management server is received and decrypted by the communication terminal, wherein the communication terminal has: a data storing function that executes a key generation process that generates an encryption key and a data ID using a terminal identification ID that is a character string specific to the communication terminal, an encryption process that encrypts the secret data using the encryption key, and a secret data storing process that transmits, to the data management server, the secret data encrypted by the encryption process together with the data ID, and causes the data management server to associate the secret data with the data ID and to store the associated data and ID; and a data reading function that executes: a key regeneration process that generates again the encryption key and the data ID using the terminal identification ID stored in a memory of the communication terminal, a request process that transmits the data ID to the data management server to request the data management server to transmit the secret data corresponding to the data ID, and a decryption process that decrypts the secret data received from the data management server, using the encryption key.

Preferably, in the data management system according to the present invention, the data storing function further has a discard process that causes the communication terminal to discard the encryption key and the data ID after the encryption process.

Preferably, in the data management system according to the present invention, the communication terminal further has a terminal identification ID storing process that receives the terminal identification ID from the data management server, and internally stores the received ID.

Preferably, in the data management system according to the present invention, the communication terminal receives a first web display program that includes a first input form, from a first web server, and stores the secret data input in the first input form, using the data storing function.

Preferably, in the data management system according to the present invention, the communication terminal receives a second web display program that includes a second input form, from a second web server, receives and decrypts the secret data stored in the data management server, using the data reading function, and performs automatic completion into the second input form, using the decrypted secret data.

Preferably, in the data management system according to the present invention, the communication terminal receives a web display program from a web server, the web display program includes a tag to cause the communication terminal to access the data management server, and a computer processor of the communication terminal executes the tag to cause the communication terminal to request, from the data management server, transmission of a program to construct the data storing function in the communication terminal.

Preferably, in the data management system according to the present invention, the communication terminal receives a web display program from a web server, the web display program includes a tag to cause the communication terminal to access the data management server, and a computer processor of the communication terminal executes the tag to cause the communication terminal to request, from the data management server, a program to construct the data reading function in the communication terminal.

A program recording medium according to the present invention is a non-transitory computer-readable recording medium that stores a computer program to be executed by a computer apparatus having a communication function, wherein the computer program constructs a data storing function and a data reading function in a communication terminal, the data storing function executes: a key generation process that generates an encryption key and a data ID using a terminal identification ID that is a character string specific to the communication terminal; an encryption process that encrypts secret data using the encryption key; and a secret data storing process that transmits, to the data management server, the secret data encrypted by the encryption process together with the data ID, and causes a data management server to associate the secret data with the data ID and to store the associated data and ID, and the data reading function executes: a key regeneration process that generates again the encryption key and the data ID using the terminal identification ID stored in a memory of the communication terminal; a request process that transmits the data ID to the data management server to request the data management server to transmit the secret data corresponding to the data ID; and a decryption process that decrypts the secret data received from the data management server, using the encryption key.

A communication terminal according to the present invention is a communication terminal that transmits encrypted secret data to an outside, and receives the secret data from the outside and decrypts the data, wherein the communication terminal has a data storing function and a data reading function, the data storing function executes: a key generation process that generates an encryption key and a data ID using a terminal identification ID that is a character string specific to the communication terminal; an encryption process that encrypts the secret data using the encryption key; and a secret data storing process that transmits the secret data encrypted by the encryption process together with the data ID, and associates the secret data with the data ID and stores the associated data and ID in an outside, and the data reading function executes: a key regeneration process that generates again the encryption key and the data ID using the terminal identification ID stored in a memory of the communication terminal; a request process that transmits the data ID to the outside to request transmission of the secret data corresponding to the data ID; and a decryption process that decrypts the secret data received from the outside, using the encryption key.

A data management server according to the present invention is a data management server connected in communication to the communication terminal according to the present invention, wherein the server receives the secret data and the data ID from the communication terminal, associates the secret data with the data ID, and stores the associated data and ID in a data storage, and reads, from the data storage, the secret data corresponding to the data ID received from the communication terminal, and transmits the read data to the communication terminal.

According to the data management system of the present invention, the secret data is encrypted and decrypted in the communication terminal. Consequently, the secret data can be prevented from being leaked on the communication line.

According to the data management system of the present invention, the secret data is identified using the data ID generated from the terminal identification ID through the key generation process. The terminal identification data is not required to be stored by a terminal user in a form of memorandum or the like. Consequently, the terminal identification ID of the present invention has a lower possibility of being leaked at places other than the communication line than that in the case of using the authentication ID to identify the secret data. The present invention can therefore reduce the possibility of leakage of the secret data.

According to the data management system of the present invention, the communication terminal can discard the encryption key and the data ID after the encryption process. Consequently, the secret data can be further securely prevented from being leaked.

According to the data management system of the present invention, the terminal identification ID issued by the data management server can be used. Consequently, the data ID generated from the terminal identification ID can be further securely prevented from being leaked.

According to the data management system of the present invention, the secret data filled in the first input form can be easily and securely stored in the data management server.

According to the data management system of the present invention, the secret data stored in the data management server can be easily and securely filled in the second input form.

In the data management system according to the present invention, the tag can be embedded in the web display program received from the web server, and the data storing function and/or the data reading function can be constructed in the communication terminal by executing this tag. This construction allows a general-purpose computer apparatus to function as the communication terminal of the present invention without installation of a dedicated program.

The recording medium of the present invention allows a general-purpose computer apparatus to function as the communication terminal of the present invention.

According to the communication terminal of the present invention, the secret data is encrypted and decrypted in the communication terminal. Consequently, externally stored secret data can be prevented from being leaked on the communication line. Moreover, according to the communication terminal of the present invention, the secret data can be identified using the data ID generated from the terminal identification ID. Consequently, the terminal identification ID can be prevented from being leaked.

The data management server of the present invention stores the secret data encrypted in the communication terminal, and transmits the data in an encrypted state as it is to the communication terminal. Consequently, the secret data can be prevented from being leaked on the communication line.

### BRIEF DESCRIPTION OF THE DRAWINGS

Other objects and advantages of the present invention are described with reference to the following accompanying drawings.

FIG. 1 is a conceptual diagram showing a network configuration of a data management system according to an embodiment of present invention;

FIG. 2 is a block diagram showing a functional configuration of a data management server according to the embodiment of the present invention;

FIGS. 3A and 3B are conceptual diagrams showing examples of input forms according to the embodiment of the present invention;

FIG. 4 is a schematic flowchart showing an encryption process of a communication terminal according to the embodiment of the present invention; and

FIG. 5 is a schematic flowchart showing a decryption process of a communication terminal according to the embodiment of the present invention.

### DETAILED DESCRIPTION

Embodiments of the present invention are hereinafter described with reference to the drawings.

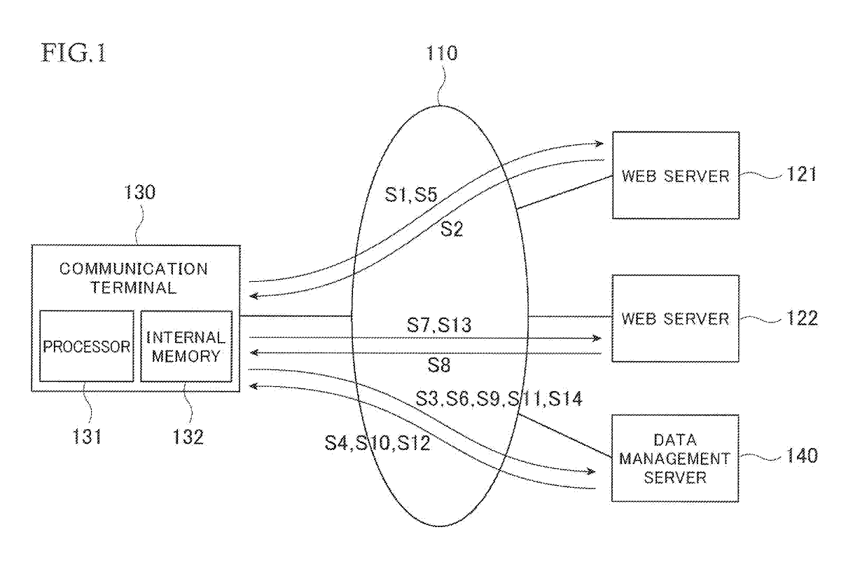

As shown in FIG. 1, a communication network 110 is connected in communication with a plurality web servers (here, only two web servers 121 and 122 are shown), a communication terminal 130, and a data management server 140.

The communication network 110 may be, for example, the Internet. Alternatively, this network may be another communication network, such as an LAN (Local Area Network).

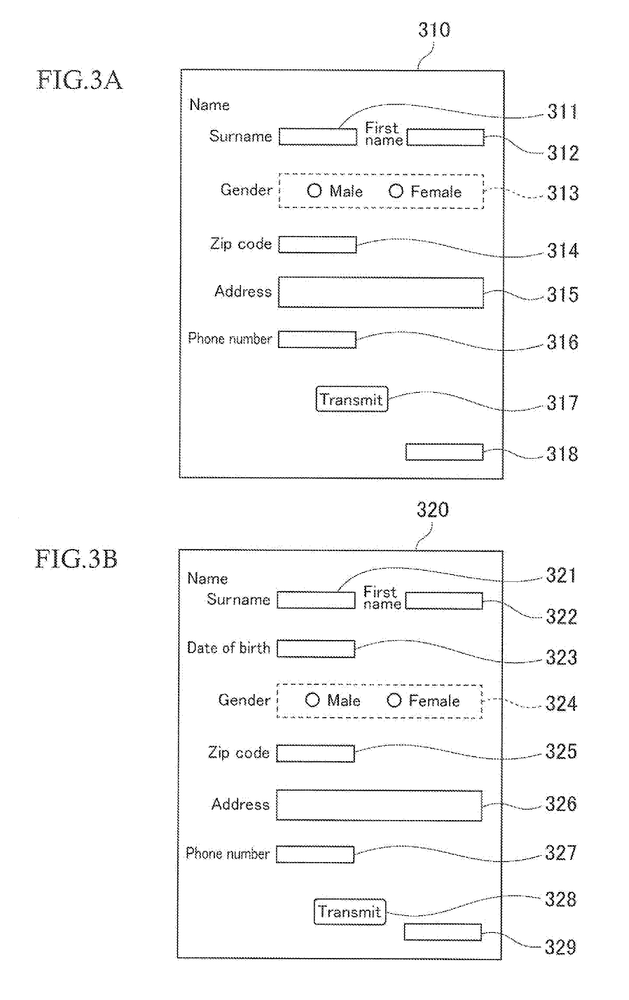

The web servers 121 and 122 store many web display programs. The web display program is a program for allowing the communication terminal to display web pages. The web display programs stored in the web servers 121 and 122 are transmitted to the communication terminal 130 when the communication terminal 130 accesses the web servers 121 and 122. In this embodiment, a program that allows the communication terminal 130 to display input forms (see FIGS. 3A and 3B described later) are included as at least a part of the web display program.

The communication terminal 130 is, for example, a personal computer, a mobile phone, a smart phone or the like. The communication terminal 130 includes a processor 131 and an internal memory 132.

The processor 131 accesses the web servers 121 and 122 using, for example, a web browser, executes the received web display program, and displays the web page. In this embodiment, the processor 131 executes a tag included in the web display program to transmit automatically various request signals to the data management server 140 (the details are described later). Furthermore, in this embodiment, the processor 131 executes a process that receives a key creation program and an encryption and decryption program from the data management server 140 and executes the programs to encrypt personal information data (corresponding to “secret data” of the present invention) stored in the internal memory 132 of the communication terminal 130 and to store the data in the data management server 140 (hereinafter, simply described as “encryption process”), and a process that receives again the key creation program and the encryption and decryption program from the data management server 140 and executes the programs to receive the personal information data from the data management server 140, decrypt the data and store the data in the internal memory 132 (hereinafter, simply described as “decryption process”) (the details are described later).

The internal memory 132 is used to store the personal information data (the details are described later). Instead of the internal memory 132, a memory outside of the communication terminal 130 may be used. However, to prevent leakage of stored information, it is preferable to use an internal memory of the communication terminal 130.

The data management server 140 receives the encrypted personal information data (hereinafter, described as “encrypted data”) from the communication terminal 130 and stores the data. Furthermore, the data management server 140 provides the communication terminal 130 with the encrypted data, the key creation program and the encryption and decryption program.

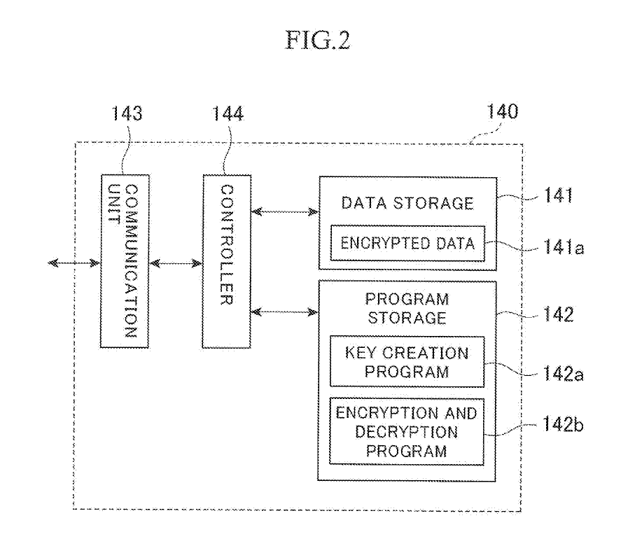

FIG. 2 is a block diagram conceptually showing the functional configuration of the data management server 140. As shown in FIG. 2, the data management server 140 includes a data storage 141, a program storage 142, a communication unit 143, and a controller 144. These elements 141 to 144 may be configured entirely in hardware, or partially in software.

In the data management server 140 in FIG. 2, the data storage 141 stores encrypted data 141a. As described above, the encrypted data 141a is data obtained by encrypting personal information data on a user of the communication terminal 130. The encrypted data 141a is individually created for each communication terminal 130 (or each user of the communication terminal 130). However, only one of the data items is shown in FIG. 2.

The program storage 142 stores the key creation program 142a and the encryption and decryption program 142b, which are to be executed by the communication terminal 130. The key creation program 142a and the encryption and decryption program 142b are used to cause the communication terminal 130 to execute the encryption process and the decryption process as described above (the details are described later). The key creation program 142a and the encryption and decryption program 142b which are common to all the web sites may be used.

The communication unit 143 receives various request signals from the communication terminal 130 via the communication network 110, and transmits the signals to the controller 144. The communication unit 143 receives the encrypted data 141a, the key creation program 142a and the encryption and decryption program 142b from the controller 144, and transmits the data and programs to the communication terminal 130 via the communication network 110.

According to the various request signals received from the communication unit 143, the controller 144 transmits the encrypted data 141a and the programs 142a and 142b to the communication unit 143, and issues a terminal identification ID for the communication terminal 130 and causes the communication unit 143 to transmit the ID.

FIG. 3A is a conceptual diagram showing an example of an input form displayed on a screen of the communication terminal 130. Here, the input form 310 is provided by the web server 121 (see FIG. 1).

As shown in FIG. 3A, the input form 310 includes input fields 311 to 316 into which “Surname”, “First name”, “Gender”, “Zip code”, “Address” and “Phone number” are to be input, and a transmission button 317 and a tag 318. Here, the transmission button 317 is used to transmit the information input in each of the input fields 311 to 316. The tag 318 is originally used for displaying, in a partial region of a web page, another web page. However, in this embodiment, the tag is used to generate and transmit various request signals, and to execute the key creation program 142a and the encryption and decryption program 142b received from the data management server 140 (described later).

FIG. 3B is a conceptual diagram showing another example of an input form displayed on a screen of the communication terminal 130. Here, the input form 320 is provided by the web server 122 (see FIG. 1).

As shown in FIG. 3B, the input form 320 also includes input fields 321 to 327 into which “Surname”, “First name”, “Date of birth”, “Gender”, “Zip code”, “Address” and “Phone number” are to be input, and a transmission button 328 and a tag 329. The transmission button 328 and the tag 329 are analogous to the transmission button 317 and the tag 318 in FIG. 3A.

Next, operations of this embodiment are described.

First, a process of inputting personal information data into the input form and of storing the data into the data management server 140 is described. In this process, an encryption process for the personal information data is performed.

First, the processor 131 of the communication terminal 130 activates the web browser of the communication terminal 130, and causes the web browser to access a desired web site (here, a web site of the web server 121) (see a symbol S1 in FIG. 1). The web server 121 thus transmits the web display program of the corresponding web page to the communication terminal 130 (see a symbol S2 in FIG. 2).

The processor 131 of the communication terminal 130 executes the web display program. Consequently, the web page (the input form 310 in FIG. 3A) is displayed on the screen of the communication terminal 130.

As described above, the web display program includes the tag 318. When the processor 131 of the communication terminal 130 executes the web display program, the tag 318 operates accordingly.

The tag 318 creates a program request signal. At this time, the tag 318 checks whether the terminal identification ID is stored in the internal memory 132 of the communication terminal 130 or not. In the case where the terminal identification ID is not stored, the tag 318 stores information indicating a first use and transmits the program request signal to the data management server 140 (see a symbol S3 in FIG. 1).

The communication unit 143 of the data management server 140 transfers the received program request signal to the controller 144.

Upon receipt of the program request signal, the controller 144 checks whether it is the first time or not that the data management server 140 is used by the communication terminal 130. In the case of the first use, the controller 144 generates the terminal identification ID of the communication terminal 130 using, for example, a random number generating program or the like. The key creation program 142a and the encryption and decryption program 142b are read from the program storage 142 and transmitted to the communication unit 143 together with the generated terminal identification ID. On the contrary, in the cases other than the first use, the controller 144 transmits only the key creation program 142a and the encryption and decryption program 142b to the communication unit 143. Preferably, the terminal identification ID is removed from the controller 144 after having been transmitted to the communication unit 143.

In this embodiment, the terminal identification ID is randomly generated in the data management server 140. Alternatively, the ID may be generated in the communication terminal 130. A value that has been originally set in and is specific to the communication terminal 130 (terminal identification number, MAC address, etc.) may be used as the ID.

The communication unit 143 transmits, to the communication terminal 130, the programs 142a and 142b and the terminal identification ID received from the controller 144 (see a symbol S4 in FIG.1).

Upon receipt of the programs 142a and 142b and the terminal identification ID, the tag 318 of the communication terminal 130 stores the programs and ID in the internal memory 132.

The user of the communication terminal 130 inputs information in each of the input fields 311 to 316 of the input form 310 (see FIG. 3A) using input means (e.g., a keyboard), which is not shown. The input information is stored in the internal memory 132 of the communication terminal 130 and is displayed in the input form 310. After completion of the input operation, the transmission button 317 is clicked. Thus, the information input in the input fields 311 to 316 (i.e., personal information data) is transmitted to the web server 121 (see a symbol S5 in FIG.1). Alternatively, without use of the transmission button 317, transmission may be performed through asynchronous communication, such as of Ajax (Asynchronous JavaScript (R)+XML).

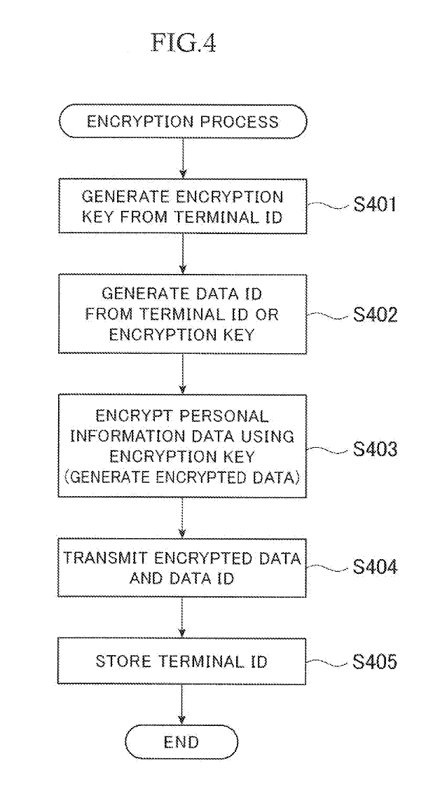

The personal information data stored in the internal memory 132 is encrypted as described below and transmitted to the data management server 140 (see FIG. 4).

First, the key creation program 142a reads the above described terminal identification ID from the internal memory 132. The key creation program 142a then generates an encryption key by applying a calculation process to the terminal identification ID (see step S401 in FIG. 4). Furthermore, the key creation program 142a generates a data ID by applying a calculation process to the encryption key (see step S402 in FIG. 4). Alternatively, the data ID may be generated from the terminal identification ID. Here, preferably, the calculation process that generates the encryption key uses a calculation expression that does not allow the inverse calculation to calculate the terminal identification ID. Likewise, preferably, the calculation process that generates the data ID uses a calculation expression that does not allow the inverse calculation to calculate the encryption key (or terminal identification ID).

Subsequently, the encryption and decryption program 142b encrypts the personal information (i.e., the information input by the user of the communication terminal 130 in each of the input fields 311 to 316 of the input form 320) stored in the internal memory 132, using the generated encryption key (see step S403 in FIG. 4). The encrypted data is thus generated.

The encryption and decryption program 142b then transmits the encrypted data together with the data ID to the data management server 140(see S6 in FIG. 1, and step S404 in FIG. 4).

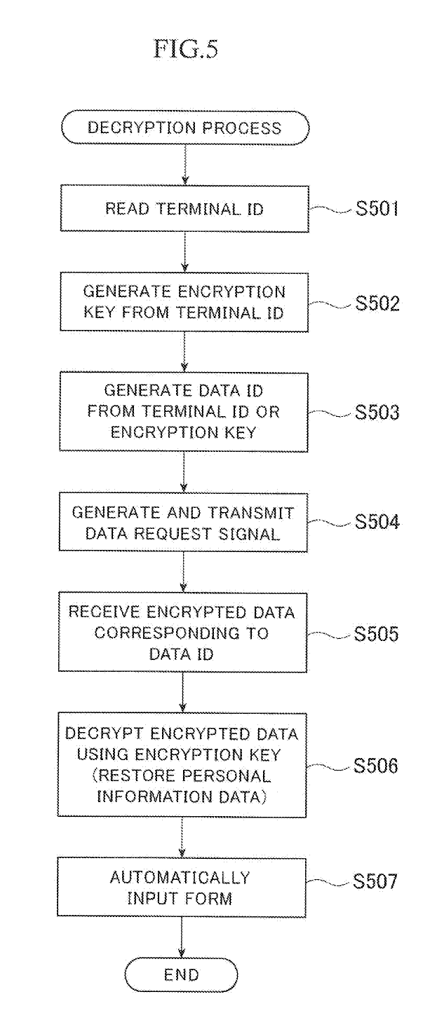

Subsequently, the encryption and decryption program 142b stores the terminal identification ID in a predetermined storage region in the internal memory 132 (see step S405 in FIG. 5).

The communication unit 143 of the data management server 140 transmits, to the controller 144, the received encrypted data and data ID. The controller 144 associates the encrypted data with the data ID, and stores the associated data and the data ID in the data storage 141.

The encryption process is thus completed.

After the encryption process, the tag 318 of the communication terminal 130 discards the encryption key and the data ID. Preferably, at this time, the tag 318 of the communication terminal 130 discards the personal information data (the input information in the input fields 311 to 316) stored in the internal memory 132, and the encrypted data.

The process of inputting the personal information data in the input form is thus completed.

Next, a process of automatically inputting the personal information data into the input form is described. In this process, an encryption process for the encrypted data is performed.

First, the processor 131 of the communication terminal 130 activates the web browser of the communication terminal 130, and causes the web browser to access a desired web site (here, a web site of the web server 122) (see a symbol S7 in FIG. 1). The web server 122 thus transmits the web display program for the corresponding web page to the communication terminal 130 (see a symbol S8 in FIG. 1).

The processor 131 of the communication terminal 130 then executes the web display program. Consequently, the web page (the input form 320 in FIG. 3B) is displayed on the screen of the communication terminal 130.

As described above, the web display program includes the tag 329. When the processor 131 of the communication terminal 130 executes the web display program, the tag 329 operates accordingly.

The tag 329 creates a program request signal. At this time, the tag 329 checks whether the terminal identification ID is stored in the internal memory 132 of the communication terminal 130 or not. Here, the terminal identification ID is stored. Consequently, the tag 329 stores information indicating not a first use to a program request signal, and transmits the program request signal to the data management server 140 (see a symbol S9 in FIG. 1).

The communication unit 143 of the data management server 140 transfers the received program request signal to the controller 144.

Upon receipt of the program request signal, the controller 144 checks whether it is the first time or not that the data management server 140 is used by the communication terminal 130. Here, this case is not the first use. Consequently, the controller 144 does not generate the terminal identification ID, reads the key creation program 142a and the encryption and decryption program 142b from the program storage 142 and transmits the programs to the communication unit 143.

The communication unit 143 transmits, to the communication terminal 130, the programs 142a and 142b received from the controller 144 (see a symbol S10 in FIG.

Upon receipt of the programs 142a and 142b, the tag 329 of the communication terminal 130 stores the programs in the internal memory 132.

The communication terminal 130 receives and decrypts the encrypted data as described below, and automatically inputs the data into the input form 320 (see FIG. 5).

First, the key creation program 142a reads the terminal identification ID from the internal memory 132 (see step S501 in FIG. 5). The key creation program 142a then generates an encryption key by applying a calculation process to the terminal identification ID (see step S502 in FIG. 5). Furthermore, the key creation program 142a generates a data ID by applying a calculation process to the encryption key or the terminal identification ID (see step S503 in FIG. 5). The terminal identification ID and the key creation program 142a are the same as those at the time of encryption (see FIG. 4). Consequently, the generated encryption key and data ID are the same as those at the time of encryption.

Next, the encryption and decryption program 142b generates the data request signal, stores the generated data ID into this data request signal, and transmits this data request signal to the data management server 140 (see S11 in FIG. 1, and step S504 in FIG. 5).

The communication unit 143 of the data management server 140 transfers the received data request signal to the controller 144.

Upon receipt of the data request signal, the controller 144 reads the data ID from the data request signal. The controller 144 then reads the encrypted data 141a corresponding the read data ID from the data storage 141, and transmits the encrypted data 141a to the communication unit 143.

The communication unit 143 transmits, to the communication terminal 130, the encrypted data 141a received from the controller 144 (see a symbol S12 in FIG.

Upon receipt of the encrypted data 141a, the encryption and decryption program 142b of the communication terminal 130 stores the data in the internal memory 132 (see step S505 in FIG. 5).

The encryption and decryption program 142b decrypts the encrypted data using the encryption key generated in the aforementioned step S502 (see step S506 in FIG. 5). The personal information data restored by this decryption is stored in the internal memory 132 of the communication terminal 130.

Subsequently, the tag 329 performs automatic completion into the input form 320 using the personal information data in the internal memory 132 (see step S507 in FIG. 5). A well-known method can be used as the method of automatic completion into the input form 320. Consequently, the description of the method is omitted.

Here, as can be understood from FIGS. 3A and 3B, the input form 310 does not have an input filed where the date of birth is input. Consequently, automatic input cannot be performed into the input field 323 of the input form 320. Thus, the user of the communication terminal 130 inputs his/her date of birth into the input field 323. Consequently, the information input into the input field 323 is added to the personal information data in the internal memory 132. For example, when the address, phone number or the like is changed, a part of the input fields 321, 322 and 324 to 327 may be changed.

The decryption process is thus completed.

The user of the communication terminal 130 clicks the transmission button 328. Thus, information input in the input fields 321 to 327 is transmitted to the web server 122 (see a symbol S13 in FIG. 1). Alternatively, without use of the transmission button 328, transmission may be performed through asynchronous communication, such as of Ajax.

Subsequently, the encryption and decryption program 142b encrypts again the information stored in the internal memory 132 using the encryption key. The encrypted data is thus generated again.

The encryption and decryption program 142b then transmits the encrypted data together with the data ID to the data management server 140 (see S14 in FIG. 1).

Subsequently, the communication terminal 130 discards the encryption key and the data ID. Preferably, at this time, the communication terminal 130 also discards the information stored in the internal memory 132 and the encrypted data.

The communication unit 143 of the data management server 140 transmits, to the controller 144, the received encrypted data and data ID. The controller 144 associates the encrypted data with the data ID, and stores the associated data and ID in the data storage 141.

The process of inputting the personal information data in the input form 320 is thus completed.

Re-encryption of the personal information data and restoring of this information into the data management server 140 after automatic completion into the input form (here, the input form 320) may be performed only when correction or addition is performed to the personal information.

In this embodiment, the same encryption key is used for the encryption process and the decryption process. Alternatively, for example, a key generating algorithm analogous to that of the public key scheme may be used and different keys may be used between encryption and decryption. Furthermore, instead of the data ID, one of the encryption key and the decryption key may be used in this case.

In this embodiment, the key creation program 142aand the encryption and decryption program 142b are stored in the data management server 140, and provided for the communication terminal 130. Alternatively, the programs may be stored in the web servers 121 and 122 and provided for the communication terminal 130.

In this embodiment, the encryption and decryption program 142b decrypts the entire personal information stored in the internal memory 132 (i.e., the entire information which the user of the communication terminal 130 has input into each of the input fields 311 to 316 of the input form 320) (see step S403 in FIG. 4). Alternatively, encrypted data that only includes a predetermined piece of personal information in the personal information input into the input fields 311 to 316 may be generated. Furthermore, input items other than the input items exemplified as the input fields 311 to 316 may be encrypted.

As described above, according to this embodiment, the personal information data is encrypted and decrypted in the communication terminal 130. Consequently, the personal information data can be prevented from being leaked on the communication line. According to this embodiment, the secret data is identified using the data ID generated from the terminal identification ID. Consequently, in case the authentication ID or the like of the terminal user is leaked, this leakage does not cause leakage of the secret data.

According to this embodiment, the communication terminal 130 discards the encryption key and the data ID after the encryption process. Consequently, the secret data can be further securely prevented from being leaked.

According to this embodiment, the terminal identification ID issued by the data management server 140 is used. Consequently, the data ID generated from the terminal identification ID can be further securely prevented from being leaked.

According to this embodiment, the personal information data filled in the input form 310 is easily and securely stored in the data management server 140.

According to this embodiment, the personal information data stored in the data management server 140 is easily and securely filled in the input form 320.

According to this embodiment, a general computer apparatus (a personal computer, mobile phone, smart phone, etc.) can be allowed to function as the communication terminal 130 of this embodiment without installation of a dedicated program.

What is claimed is:

1. A data management system in which secret data encrypted in a communication terminal is transmitted to and stored in a data management server, and the secret data stored in the data management server is received and decrypted by the communication terminal,
wherein the communication terminal has a data storing function and a data reading function,
the data storing function executes:
a key generation process that generates an encryption key and a data ID using a terminal identification ID that is a character string specific to the communication terminal;
an encryption process that encrypts the secret data using the encryption key; and
a secret data storing process that transmits, to the data management server, the secret data encrypted by the encryption process together with the data ID, and causes the data management server to associate the secret data with the data ID and to store the associated data and ID, and
the data reading function executes:
a key regeneration process that generates again the encryption key and the data ID using the terminal identification ID stored in a memory of the communication terminal;
a request process that transmits the data ID to the data management server to request the data management server to transmit the secret data corresponding to the data ID; and
a decryption process that decrypts the secret data received from the data management server, using the encryption key.

2. The data management system according to claim 1, wherein the data storing function further has a discard process that causes the communication terminal to discard the encryption key and the data ID after the encryption process.

3. The data management system according to claim 1, wherein the communication terminal further has a terminal identification ID storing process that receives the terminal identification ID from the data management server, and internally stores the received ID.

4. The data management system according to claim 1,
wherein the communication terminal receives a first web display program that includes a first input form, from a first web server, and
stores the secret data input in the first input form in the data management server, using the data storing function.

5. The data management system according to claim 1,
wherein the communication terminal receives a second web display program that includes a second input form, from a second web server,
receives and decrypts the secret data stored in the data management server, using the data reading function, and
performs automatic completion into the second input form, using the decrypted secret data.

6. The data management system according to claim 1,
wherein the communication terminal receives a web display program from a web server,
the web display program includes a tag to cause the communication terminal to access the data management server, and
a computer processor of the communication terminal executes the tag to cause the communication terminal to request, from the data management server, transmission of a program to construct the data storing function in the communication terminal.

7. The data management system according to claim 1,
wherein the communication terminal receives a web display program from a web server,
the web display program includes a tag to cause the communication terminal to access the data management server, and
a computer processor of the communication terminal executes the tag to cause the communication terminal to request, from the data management server, a program to construct the data reading function in the communication terminal.

8. A non-transitory computer-readable recording medium that stores a computer program to be executed by a computer apparatus having a communication function,
wherein the computer program constructs a data storing function and a data reading function in a communication terminal,
the data storing function executes:
a key generation process that generates an encryption key and a data ID using a terminal identification ID that is a character string specific to the communication terminal;
an encryption process that encrypts secret data using the encryption key; and
a secret data storing process that transmits, to the data management server, the secret data encrypted by the encryption process together with the data ID, and causes a data management server to associate the secret data with the data ID and to store the associated data and ID, and
the data reading function executes:
a key regeneration process that generates again the encryption key and the data ID using the terminal identification ID stored in a memory of the communication terminal;
a request process that transmits the data ID to the data management server to request the data management server to transmit the secret data corresponding to the data ID; and
a decryption process that decrypts the secret data received from the data management server, using the encryption key.

9. A communication terminal that transmits encrypted secret data to an outside, and receives the secret data from the outside and decrypts the data,
wherein the communication terminal has a data storing function and a data reading function,
the data storing function executes:
a key generation process that generates an encryption key and a data ID using a terminal identification ID that is a character string specific to the communication terminal;
an encryption process that encrypts the secret data using the encryption key; and
a secret data storing process that transmits the secret data encrypted by the encryption process together with the data ID, and associates the secret data with the data ID and stores the associated data and ID in an outside, and
the data reading function executes:
a key regeneration process that generates again the encryption key and the data ID using the terminal identification ID stored in a memory of the communication terminal;
a request process that transmits the data ID to the outside to request transmission of the secret data corresponding to the data ID; and
a decryption process that decrypts the secret data received from the outside, using the encryption key.

10. A data management server connected in communication to the communication terminal according to claim 9,
wherein the server receives the secret data and the data ID from the communication terminal, associates the secret data with the data ID, and stores the associated data and ID in a data storage, and
reads, from the data storage, the secret data corresponding to the data ID received from the communication terminal, and transmits the read data to the communication terminal.
